(19) United States
(12) Patent Application Publication
(10) Pub. No.: US 2018/0166221 A1
(43) Pub. Date: Jun. 14, 2018

(54) LOW LEAKAGE ELECTROLYTIC CAPACITOR

(71) Applicant: APAQ TECHNOLOGY CO., LTD., MIAOLI COUNTY (TW)

(72) Inventors: MING-TSUNG CHEN, CHANGHUA COUNTY (TW); CHUNG-JUI SU, KAOHSIUNG CITY (TW)

(21) Appl. No.: 15/402,355

(22) Filed: Jan. 10, 2017

(30) Foreign Application Priority Data
Dec. 12, 2016 (TW) 105141051

(51) Int. Cl. H01G 9/145; H01G 9/15; H01G 9/008; H01G 9/048; H01G 9/08; H01G 9/035; H01G 9/025; H01G 9/02

(52) U.S. Cl. CPC H01G 9/145; H01G 9/15; H01G 9/008; H01G 9/02; H01G 9/08; H01G 9/035; H01G 9/025; H01G 9/048

(57) ABSTRACT

The instant disclosure relates to a low leakage electrolytic capacitor which includes a winding-type capacitor element, a hybrid electrically conductive medium, and a package body. The winding-type capacitor element includes an anode foil, a cathode foil, and a separator interposed between the anode foil and the cathode foil. The hybrid electrically conductive medium is disposed in the winding-type capacitor element, and includes an electrically conductive polymer and an ion liquid. The package body encloses the winding-type capacitor element and the hybrid electrically conductive medium. Whereby, the instant electrolytic capacitor has good electrical properties of solid electrolytic capacitor, and the electrical leakage performance thereof can be improved.

### BACKGROUND OF THE INVENTION

### 1. Field of the Invention

The instant disclosure relates to an electrolytic capacitor, and more particularly to a low leakage electrolytic capacitor having excellent properties of both solid electrolytic capacitor and liquid electrolytic capacitor.

### 2. Description of Related Art

It is well known that the basic function of a capacitor is charging and discharging. The capacitor is mainly used to provide bypassing, coupling, filtering, oscillation, or transforming function. Various applications of the capacitor include home appliances, computer motherboards and peripherals, power supplies, communication products and automobiles.

Based on the electrolyte, electrolytic capacitors are categorized into two different types: solid electrolytic capacitor and liquid electrolytic capacitor. A solid electrolytic capacitor is a capacitor which uses a solid electrolyte (i.e. conductive polymer) as the electrolyte. A liquid electrolytic capacitor is a capacitor which uses a flowable electrolyte (i.e. electrolyte solution) as the electrolyte. Compared with the liquid electrolytic capacitor, the solid electrolytic capacitor has a relatively low equivalent series resistance (ESR), but in which an electrically conductive layer cannot be uniformly and densely formed on surfaces of a porous anode foil, and this may result in exfoliation of the electrically conductive layer. In addition, the electrically conductive layer is usually formed with a relatively thick thickness by repeatedly applying a chemical oxidation process to reduce ESR. However, these processes may also result in damage to the dielectric film. Since the solid electrolytic capacitor lacks a repair mechanism for the damage, a short circuit may occur due to the increased leakage current.

Therefore, how to provide an electrolytic capacitor to overcome the above mentioned defects becomes a problem to be solved in this field of art.

### SUMMARY OF THE INVENTION

In order to increase product reliability, the object of the instant disclosure is to provide a low leakage electrolytic capacitor which has excellent properties of solid electrolytic capacitor, and the electrical leakage performance thereof can be improved.

In order to achieve the aforementioned objects, according to a preferred embodiment of the instant disclosure, the low leakage electrolytic capacitor includes a winding-type capacitor element, a hybrid electrically conductive medium, and a package body. The winding-type capacitor element includes an anode foil, a cathode foil, and a separator interposed between the anode foil and the cathode foil. The hybrid electrically conductive medium is disposed in the winding-type capacitor element, and including an electrically conductive polymer and an ion liquid, wherein the ion liquid contains at least one cationic species selected from the group consisting of formulae (1) to (9) and at least one anionic species selected from the group consisting of formulae (10) to (17):

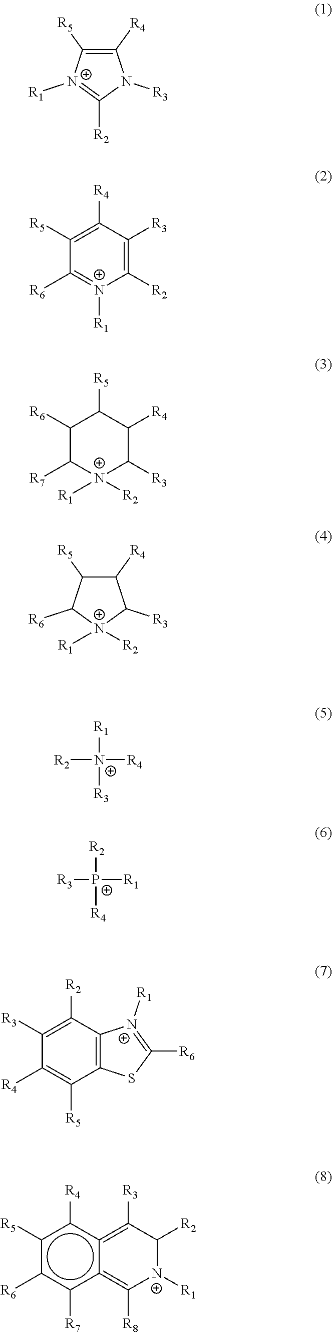

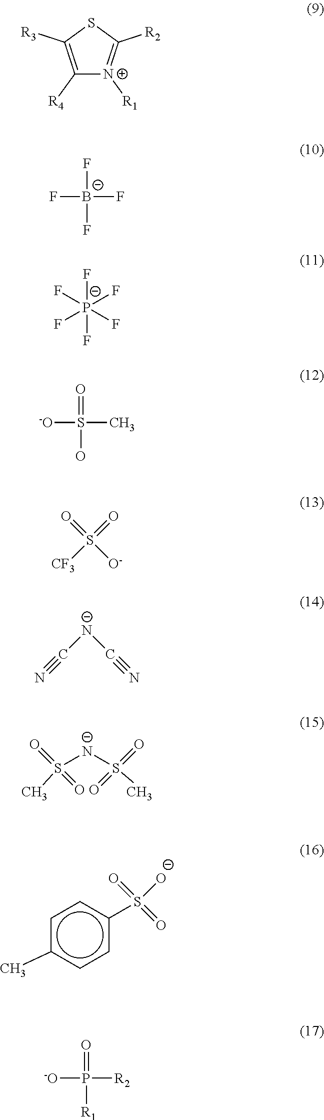

wherein R₁ to R₈ each independently represent a hydrogen atom, substituted or unsubstituted C1-C10 alkyl group, unsubstituted or substituted C1-C10 alkenyl group, unsubstituted or substituted C1-C10 alkynyl group, substituted or unsubstituted aryl group, substituted or unsubstituted heteroaryl group, acyl group, ester group, ether group, or amino group. The package body encloses the winding-type capacitor element and the hybrid electrically conductive medium.

In one embodiment, the electrically conductive polymer is polyethylene dioxythiophene doped with polystyrene-sulfonic acid (PEDOT/PSS), polythiophene (PT), polyacetylene (PA), polyaniline (PANI), or polypyrrole (PPy).

In one embodiment, the electrically conductive polymer is present in an amount of from about 1.0 to about 20.0 weight percent of the hybrid electrically conductive medium, and the ion liquid is present in an amount of from about 0.05 to about 30.0 weight percent of the hybrid electrically conductive medium.

In one embodiment, the hybrid electrically conductive medium further contains a lower volatility solvent which is present in an amount of from about 0.05 to about 50.0 weight percent of the hybrid electrically conductive medium.

In one embodiment, the lower volatility solvent is one or a combination of two or more selected from the group consisting of polyalkylene glycol or a derivative thereof, polyethylene glycol or a derivative thereof, polypropylene glycol or a derivative thereof, polytetramethylene glycol or a derivative thereof, a copolymer of ethylene glycol and propylene glycol, a copolymer of ethylene glycol and butylene glycol, and a copolymer of polypropylene glycol and butylene glycol.

In one embodiment, the hybrid electrically conductive medium further contains a carbon filler which is present in an amount of from about 0 to about 5 weight percent of the hybrid electrically conductive medium.

In one embodiment, the carbon filler includes carbon nanotube and graphene.

In one embodiment, the hybrid electrically conductive medium further contains 10 to 10000 ppm of alkaline metal or alkali earth metal ions.

The benefits of the present invention include: The hybrid electrically conductive medium contains an ion liquid and an electrically conductive polymer. The ion liquid, which can serve as a dispersing medium, is operable over a wide temperature range and has the advantages of high thermal stability, high electrical conductivity, and good electrochemical properties. The electrically conductive polymer is uniformly and stably dispersed in the ion liquid in the form of solid particles to allow easy transport of electrons and ions. The hybrid electrically conductive medium may additionally contain a lower volatility solvent for increasing thermal stability and electrical conductivity and a carbon filler for providing electrical conduction paths between the particles of the electrically conductive polymer. According, a capacitor with high mechanical strength and good electrical properties can be obtained.

To further understand the techniques, means and effects of the instant disclosure, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 is a cross-sectional view of the low leakage electrolytic capacitor according to the first embodiment of the instant disclosure;

FIG. 2 is a three-dimensional view of the winding-type capacitor element of the low leakage electrolytic capacitor according to the first embodiment of the instant disclosure;

FIG. 3 is a partial schematic view showing the winding-type capacitor element and the hybrid electrically conductive medium of the low leakage electrolytic capacitor according to the first embodiment of the instant disclosure; and

FIG. 4 is a schematic view of the low leakage electrolytic capacitor according to the second embodiment of the instant disclosure.

### DETAILED DESCRIPTION OF THE PREFERRED EMBODIMENTS

The present invention discloses a hybrid electrically conductive medium which can serve as a solid electrolyte or an electrically conductive layer for use in an electrolytic capacitor. The hybrid electrically conductive medium including an ion liquid and an electrically conductive polymer and a carbon filler uniformly dispersed in the ion liquid allows easy transport of electrons and ions. Moreover, the hybrid electrically conductive medium is provided with the functions of hole-filling, defect repairing, and current leakage preventing.

Embodiments of a low leakage electrolytic capacitor according to the instant disclosure are described herein. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

Notably, the terms first, second, third, etc., may be used herein to describe various elements or signals, but these signals should not be affected by such elements or terms. Such terminology is used to distinguish one element from another or a signal with another signal. Further, the term “or” as used herein in the case may include any one or combinations of the associated listed items.

### First Embodiment

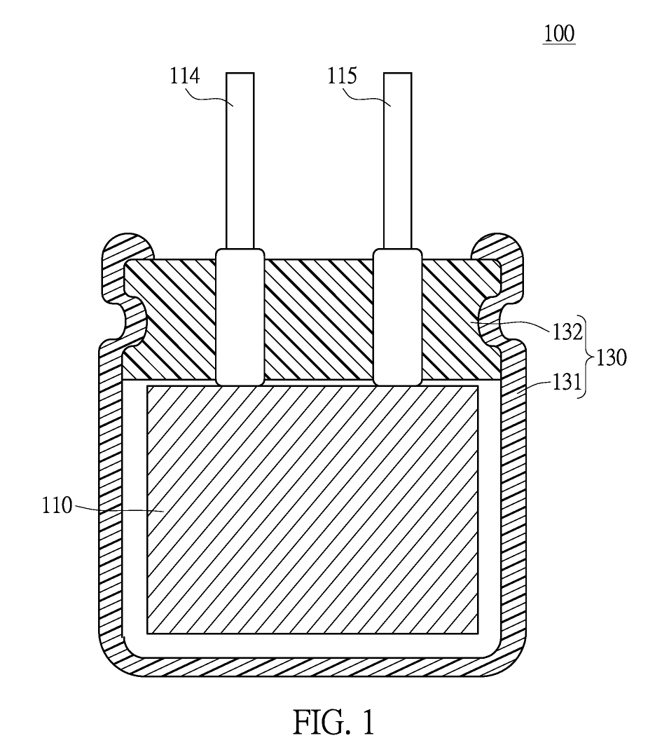

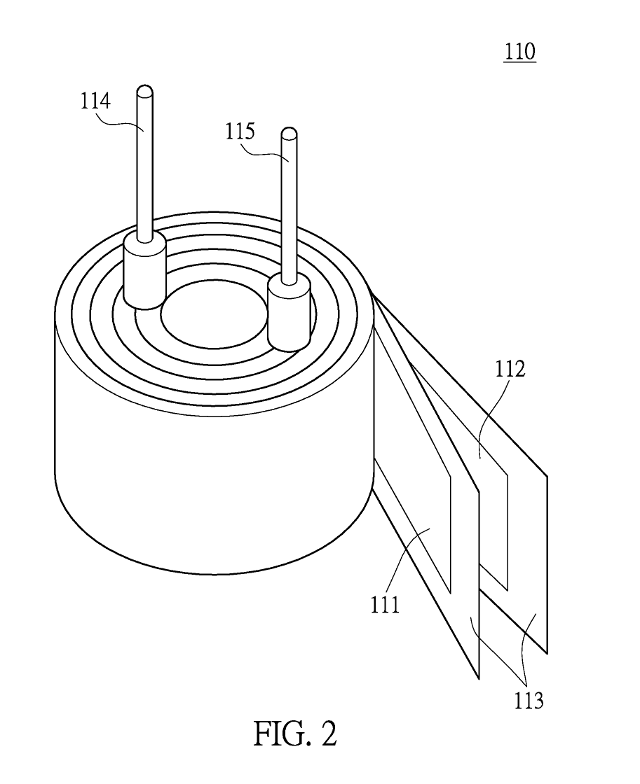

Please refer to FIGS. 1 and 2. FIG. 1 is a cross-sectional view of the low leakage electrolytic capacitor according to the first embodiment of the instant disclosure. FIG. 2 is a three-dimensional view of a winding-type capacitor element of the low leakage electrolytic capacitor. The low leakage electrolytic capacitor 100 includes a winding-type capacitor element 110, a hybrid electrically conductive medium 120, and a package body 130. The winding-type capacitor element 110 includes an anode foil 111, a cathode foil 112, and a separator 113 interposed between the anode foil 111 and the cathode foil 112. The hybrid electrically conductive medium 120 is disposed in the winding-type capacitor element 110. The package body 130 encloses the winding-type capacitor element 110 and the hybrid electrically conductive medium 120.

Initially, an anode lead 114 is attached to the anode foil 111, and a cathode lead 115 is attached to the cathode foil 112. Thereafter, the anode foil 111 and the cathode foil 112 are wound into a cylindrical shape with the separator 113 being interposed therebetween and taped with a stop tape (not shown). For the instant embodiment, the anode foil 111 and the cathode foil 112 can be made of a valve metal (e.g. aluminum, tantalum, niobium, or titanium). Preferably, the cathode foil 112 is a titanium foil which has good corrosion-resistance and be adapted to prevent broken circuit to increase capacitor reliability.

Moreover, the anode foil 111 and the cathode foil 112 can be formed with pores by a corrosion process, and respectively having a dielectric film (not shown) formed thereon by a chemical oxidation process. In practice, the porous anode and cathode foils 111, 112 having a predetermined pore configuration can be obtained by a corrosion process with no voltage applied or a corrosion process with externally applied voltage to meet capacitance characteristics required by the capacitors, and the dielectric films having a desired thickness can be formed under predetermined oxidation conditions.

The separator 113 can be a porous membrane separator made of cellulose, kraft paper, polyethylene (PE), polypropylene (PP), Teflon®, polyethylene terephthalate (PET), polybutylene terephthalate (PBT), polyphenylene sulfide (PPS), polyimide (PI), polyalkylenimine (PAI), polyethylenimine (PEI), or rayon, but it is merely an example and is not meant to limit the instant disclosure. In the case where short circuit failure does not occur, the separator 113 with a relatively low density and a relatively thin thickness can be used in the winding-type capacitor element 110 to reduce electrical resistance.

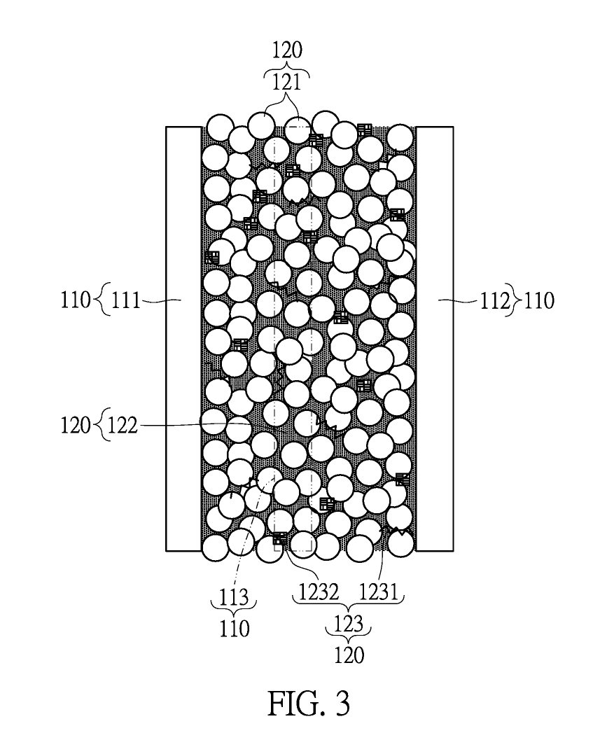

Please refer to FIG. 3. To further describe the composition of the hybrid electrically conductive medium 120, attention should be given to the following detailed description. The hybrid electrically conductive medium 120 mainly includes an electrically conductive polymer 121 and an ion liquid 122. Please note that the ion liquid 122 is operable over a wide temperature range (−96° C.˜400° C.) and has the advantages of high thermal stability, high electrical conductivity, and good electrochemical properties. Accordingly, the ion liquid 122 can serve as a dispersing medium and replace any solvent for uniform dispersion of the electrically conductive polymer 121 that is in the form of solid particles, thereby allowing easy transport of electrons and ions.

Specific examples of the electrically conductive polymer polyethylene 121 include dioxythiophene doped with polystyrene-sulfonic acid (PEDOT/PSS), polythiophene (PT), polyacetylene (PA), polyaniline (PANI), and polypyrrole (PPy). Please note that said polymers have the advantages of high electrical conductivity, good heat resistance and temperature characteristics, and strong affinity for adherence to the dielectric layer without damaging it and will not deteriorate under applied voltage. Therefore, said polymers are suitable for use in an electrolytic capacitor.

The ion liquid 122 contains at least one cationic species selected from the group consisting of formulae (1) to (9):

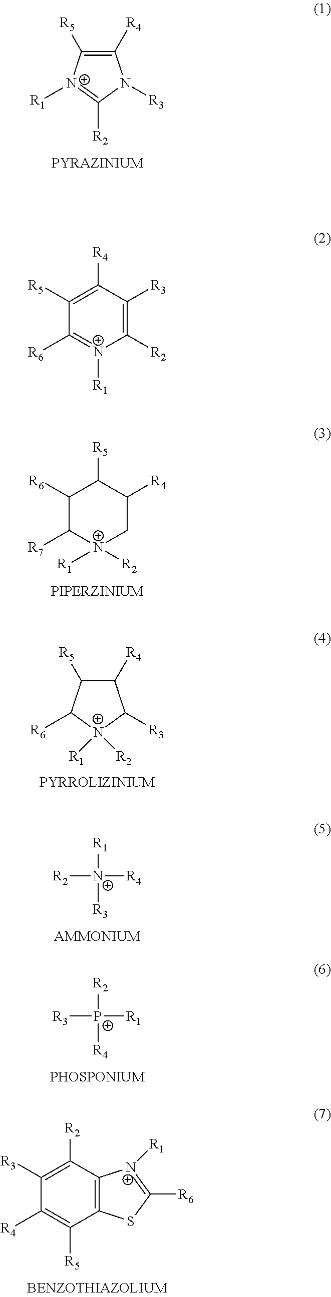

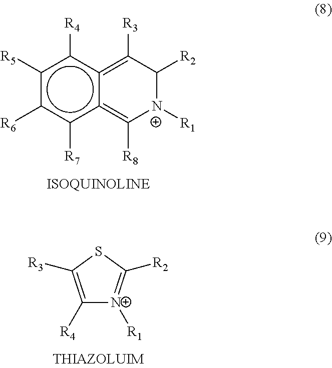

wherein R₁ to R₈ each independently represent a hydrogen atom, substituted or unsubstituted C1-C10 alkyl group, unsubstituted or substituted C1-C10 alkenyl group, unsubstituted or substituted C1-C10 alkynyl group, substituted or unsubstituted aryl group, substituted or unsubstituted heteroaryl group, acyl group, ester group, ether group, or amino group.

The ion liquid 122 also contains at least one anionic species selected from the group consisting of formulae (10) to (17):

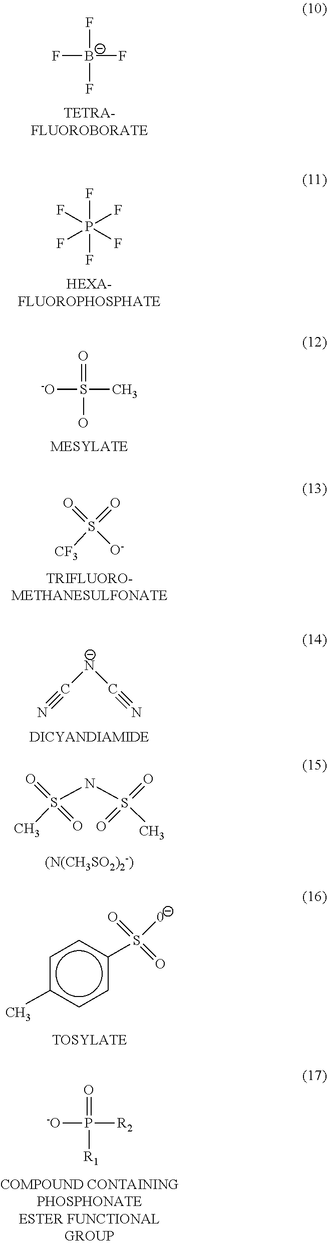

wherein R₁ to R₈ each independently represent a hydrogen atom, substituted or unsubstituted C1-C10 alkyl group, unsubstituted or substituted C1-C10 alkenyl group, unsubstituted or substituted C1-C10 alkynyl group, substituted or unsubstituted aryl group, substituted or unsubstituted heteroaryl group, acyl group, ester group, ether group, or amino group.

As used herein, the term “ionic liquid” generally refers to a polymer that is a liquid at a temperature of about 200° C. or less, in some embodiments about 150° C. or less, in some embodiments about 100° C. or less, and in some embodiments, from about 10° C. to about 60° C. By “liquid”, it is meant that the polymer may have a discernible melting point (based on DSC analysis) or simply be flowable at the indicated temperature. For example, a flowable polymer may exhibit a viscosity of less than about 10,000 mPas at the indicated temperature. Thus, the liquid state of an ionic liquid is meant to encompass all of these embodiments, including the molten state and the flowable state.

As used herein, the term “heteroaryl” generally refers to a substituted or unsubstituted aromatic group of from 1 to 14 carbon atoms and 1 to 6 heteroatoms selected from oxygen, nitrogen, sulfur, and phosphorous, and includes single ring (e.g., imidazolyl) and multiple ring systems (e.g., benzimidazol-2-yl and benzimidazol-6-yl). For multiple ring systems, including fused, bridged, and spiro ring systems having aromatic and non-aromatic rings, the term “heteroaryl” applies if there is at least one ring heteroatom and the point of attachment is at an atom of an aromatic ring (e.g., 1,2,3,4-tetrahydroquinolin-6-yl and 5,6,7,8-tetrahydroquindin-3-yl). Examples of heteroaryl groups include pyridyl, furanyl, thienyl, thiazolyl, isothiazolyl, triazolyl, imidazolyl, imidazolinyl, oxazolyl, isoxazolyl, pyrrolyl, pyrazolyl, pyridazinyl, pyrimidinyl, purinyl, phthalazyl, naphthylpryidyl, benzofuranyl, tetrahydrobenzofuranyl, isobenzofuranyl, benzothiazolyl, benzoisothiazolyl, benzotriazolyl, indolyl, isoindolyl, indolizinyl, dihydroindolyl, indazolyl, indolinyl, benzoxazolyl, quinolyl, isoquinolyl, quinolizyl, quianazolyl, quinoxalyl, tetrahydroquinolinyl, isoquinolyl, quinazolinonyl, benzimidazolyl, benzisoxazolyl, benzothienyl, benzopyridazinyl, pteridinyl, carbazolyl, carbolinyl, phenanthridinyl, acridinyl, phenanthrolinyl, phenazinyl, phenoxazinyl, phenothiazinyl, and phthalimidyl. The heteroaryl groups may optionally be substituted with from 1 to 8 or in some embodiments 1 to 5, or 1 to 3, or 1 to 2 substituents.

The hybrid electrically conductive medium 120 may additionally contain a lower volatility solvent for increasing thermal stability and electrical conductivity within the ranges that are not detrimental to desired effects of the present invention. The lower volatility solvent is one or a combination of two or more selected from the group consisting of polyalkylene glycol or a derivative thereof, polyethylene glycol or a derivative thereof, polypropylene glycol or a derivative thereof, polytetramethylene glycol or a derivative thereof, a copolymer of ethylene glycol and propylene glycol, a copolymer of ethylene glycol and butylene glycol, and a copolymer of polypropylene glycol and butylene glycol.

The hybrid electrically conductive medium 120 may additionally contain a carbon filler 123 for providing electrical conduction paths between the particles of the electrically conductive polymer 121 within the ranges that are not detrimental to desired effects of the present invention. The carbon filler 123 includes, but is not limited to, carbon nanotube and graphene. According, a capacitor with high mechanical strength and good electrical properties can be obtained.

Please note that each of the components of the hybrid electrically conductive medium 120 is present in a specific weight ratio range. Accordingly, the hybrid electrically conductive medium 120 can be provided with the functions of hole-filling, defect repairing, and current leakage preventing, and vacant spaces in the winding-type capacitor element 110 can be fully filled with the hybrid electrically conductive medium 120. Specifically, the electrically conductive polymer 121 is present in an amount of from about 1.0 to about 20.0 weight percent of the hybrid electrically conductive medium 120, preferably from about 2 to about 8 weight percent. The electrically conductive polymer 121 is preferably PEDOT/PSS. The ion liquid 122 is present in an amount of from about 0.05 to about 30.0 weight percent of the hybrid electrically conductive medium 120, preferably from about 0.05 to about 5 weight percent. The lower volatility solvent is present in an amount of from about 0.05 to about 50.0 weight percent of the hybrid electrically conductive medium 120, preferably from about 3 to about 10 weight percent. The carbon filler 123 is present in an amount of from about 0 to about 5 weight percent of the hybrid electrically conductive medium 120, preferably from about 0.05 to about 3 weight percent. The carbon filler 123 preferably includes carbon nanotube and grapheme.

For the instant embodiment, the ion liquid 122 contains at least one specific cationic species and at least one specific anionic species that can be mixed in either different ratios or the same ratio to form at least one ionic compound. The precursor of the cationic species can be an ionic compound having a halogen ion. The precursor of the anionic species can be a metal compound having an alkali metal ion or an alkaline earth metal ion. In practice, the ion liquid 122 can be obtained by mixing the precursors of the cationic species and the anionic species in either different ratios or the same ratio, and it is necessary that the molar ratio of the cationic species to the anionic species is from about 0.9 to about 2. Accordingly, the hybrid electrically conductive medium 120 having an ion concentration of alkaline metal or alkali earth metal ions between 10 to 10000 ppm can be used in the electrically conductive layer to the increase electrical conduction.

The package body 130 includes a case 131 and a sealing member 132 (e.g. closure) for sealing the case 131. Specifically, the case 131 is in configured to accommodate the winding-type capacitor element 110. In other words, the winding-type capacitor element 110 is housed in the case 131. The sealing member 132 is fixed to an opening of the case 131 to prevent entry of moisture, dust, or other impurities and to ensure normal operation of the winding-type capacitor element 110. The sealing member 132 can be made of resilient material such rubber, plastic, or the like and formed with a pair of through holes (not shown) to expose a portion of the anode and cathode leads 114, 115 for electrical connection.

TABLE 1

| | | Cap | ESR |
|---|---|---|---|
| | Composition of electrolyte | (μF) | (mΩ) |
| Comparative | conventional electrolyte 1 | 48.2 | 15.1 |
| Example 1 | | | |
| Example 1 | electrically conductive polymer: | 49.2 | 14.2 |
| | PEDOT:PSS | | |
| | Ion liquid 1: | | |
| | cationic species as shown in | | |
| | formulae (1) and anionic species as | | |
| | shown in formulae (1) | | |
| | carbon filler: | | |
| | CNT and graphene | | |
| Example 2 | electrically conductive polymer: | 49.1 | 13.8 |
| | PEDOT:PSS | | |
| | Ion liquid 2: | | |
| | cationic species as shown in | | |
| | formulae (1) and anionic species as | | |
| | shown in formulae (2) | | |
| | carbon filler: | | |
| | CNT and graphene | | |
| Example 3 | electrically conductive polymer: | 49.5 | 14.3 |
| | PEDOT:PSS | | |
| | Ion liquid 3: | | |
| | cationic species as shown in | | |
| | formulae (1) and anionic species as | | |
| | shown in formulae (3) | | |
| | carbon filler: | | |
| | CNT and graphene | | |
| Example 4 | electrically conductive polymer: | 49.8 | 13.5 |
| | PEDOT:PSS | | |
| | Ion liquid 4: | | |
| | cationic species as shown in | | |
| | formulae (2) and anionic species as | | |
| | shown in formulae (1) | | |
| | carbon filler: | | |
| | CNT and graphene | | |
| Example 5 | electrically conductive polymer: | 47.7 | 16.1 |
| | PEDOT:PSS | | |
| | Ion liquid 5: | | |
| | cationic species as shown in | | |
| | formulae (2) and anionic species as | | |
| | shown in formulae (2) | | |
| | carbon filler: | | |
| | CNT and graphene | | |
| Example 6 | electrically conductive polymer: | 48.0 | 13.9 |
| | PEDOT:PSS | | |
| | Ion liquid 6: | | |
| | cationic species as shown in | | |
| | formulae (2) and anionic species as | | |
| | shown in formulae (3) | | |
| | carbon filler: | | |
| | CNT and graphene | | |
| Example 7 | electrically conductive polymer: | 46.9 | 15.4 |
| | PEDOT:PSS | | |
| | Ion liquid 7: | | |
| | cationic species as shown in | | |
| | formulae (3) and anionic species as | | |
| | shown in formulae (2) | | |
| | carbon filler: | | |
| | CNT and graphene | | |
| Example 8 | electrically conductive polymer: | 48.8 | 14.6 |
| | PEDOT:PSS | | |
| | Ion liquid 8: | | |
| | cationic species as shown in | | |
| | formulae (3) and anionic species as | | |
| | shown in formulae (3) | | |
| | carbon filler: | | |
| | CNT and graphene | | |
| Example 9 | electrically conductive polymer: | 49.2 | 14.7 |
| | PEDOT:PSS | | |
| | Ion liquid 9: | | |
| | cationic species as shown in | | |
| | formulae (4) and anionic species as | | |
| | shown in formulae (1) | | |
| | carbon filler: | | |
| | CNT and graphene | | |
| Example 10 | electrically conductive polymer: | 49.1 | 13.8 |
| | PEDOT:PSS | | |
| | Ion liquid 10: | | |
| | cationic species as shown in | | |
| | formulae (4) and anionic species as | | |
| | shown in formulae (2) | | |
| | carbon filler: | | |
| | CNT and graphene | | |

TABLE 2

| | | Cap | ESR |
|---|---|---|---|
| | Composition of electrolyte | (μF) | (mΩ) |
| Comparative | electrically conductive polymer: | 48.2 | 15.1 |
| Example 1 | PEDOT:PSS | | |
| Example 11 | electrically conductive polymer: | 48.7 | 14.1 |
| | PEDOT:PSS | | |
| | carbon filler: | | |
| | 0.1 wt % of CNT | | |
| Example 12 | electrically conductive polymer: | 49.5 | 13.6 |
| | PEDOT:PSS | | |
| | carbon filler: | | |
| | 0.5 wt % of CNT | | |
| Example 13 | electrically conductive polymer: | 49.5 | 12.9 |
| | PEDOT:PSS | | |
| | carbon filler: | | |
| | 1 wt % of CNT | | |
| Example 14 | electrically conductive polymer: | 48.9 | 13.7 |
| | PEDOT:PSS | | |
| | carbon filler: | | |
| | 0.1 wt % of graphene | | |
| Example 15 | electrically conductive polymer: | 49.0 | 12.1 |
| | PEDOT:PSS | | |
| | carbon filler: | | |
| | 0.3 wt % of graphene | | |
| Example 16 | electrically conductive polymer: | 49.0 | 13.9 |
| | PEDOT:PSS | | |
| | carbon filler: | | |
| | 0.5 wt % of graphene | | |
| Example 17 | electrically conductive polymer: | 49.2 | 11.4 |
| | PEDOT:PSS | | |
| | carbon filler: | | |
| | 0.3 wt % of CNT and graphene | | |
| Example 18 | electrically conductive polymer: | 48.8 | 11.2 |
| | PEDOT:PSS | | |
| | carbon filler: | | |
| | 1 wt % of CNT and graphene | | |

TABLE 3

| | | Cap | ESR |
|---|---|---|---|
| | Composition of electrolyte | (μF) | (mΩ) |
| Comparative | electrically conductive polymer: | 48.2 | 15.1 |
| Example 1 | PEDOT:PSS | | |
| Example 21 | electrically conductive polymer: | 49.5 | 13.1 |
| | PEDOT:PSS | | |
| | Ion liquid 1: | | |
| | 0.5% of cationic species as shown | | |
| | in formulae (1) and anionic species | | |
| | as shown in formulae (1) | | |
| | carbon filler: | | |
| | 0.1 wt % of CNT | | |
| Example 22 | electrically conductive polymer: | 49.5 | 13.6 |
| | PEDOT:PSS | | |
| | Ion liquid 1: | | |
| | 2% of cationic species as shown in | | |
| | formulae (1) and anionic species | | |
| | as shown in formulae (1) | | |
| | carbon filler: | | |
| | 0.1 wt % of CNT | | |
| Example 23 | electrically conductive polymer: | 50.1 | 12.5 |
| | PEDOT:PSS | | |
| | Ion liquid 4: | | |
| | 3% of cationic species as shown in | | |
| | formulae (3) and anionic species | | |
| | as shown in formulae (3) | | |
| | carbon filler: | | |
| | 0.5 wt % of graphene | | |
| Example 24 | electrically conductive polymer: | 50.2 | 11.7 |
| | PEDOT:PSS | | |
| | Ion liquid 4: | | |
| | 3% of cationic species as shown in | | |
| | formulae (3) and anionic species | | |
| | as shown in formulae (3) | | |
| | carbon filler: | | |
| | 1 wt % of graphene | | |

### Second Embodiment

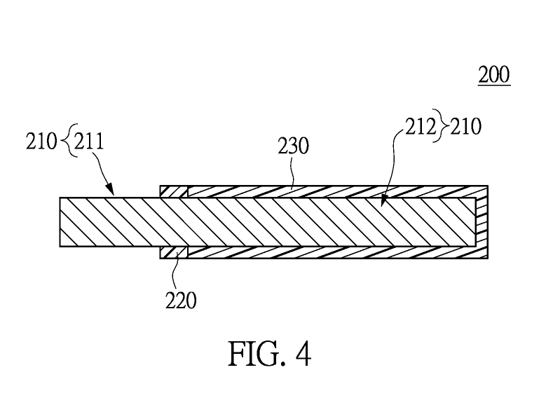

Please refer to FIG. 4. FIG. 4 is a schematic view of the low leakage electrolytic capacitor according to the second embodiment of the instant disclosure. The low leakage electrolytic capacitor 200 includes a substrate layer 210, a surrounding insulating layer 220, and an electrically conductive layer 230. The surrounding insulating layer 220 is disposed on the outer surface of the substrate layer 210 to define an anode part 211 and a cathode part 212 spaced from each other. The electrically conductive layer 230 covers the cathode part 212 of the substrate layer 210.

For the instant embodiment, the substrate layer 210 can be made of a valve metal (e.g. aluminum, tantalum, niobium, or titanium). The substrate layer 210 can be formed with pores by a corrosion process with no voltage applied or a corrosion process with externally applied voltage, and having a dielectric film (not shown) formed thereon by a chemical oxidation process. Please note that the electrically conductive layer 230 contains an electrically conductive polymer, an ion liquid, and a carbon filler, where specific details of which are similar to that described in the first embodiment and will not repeat herein. The electrically conductive layer 230 has a thickness which can range from 50 μm to 500 μm, preferably from 80 μm to 200 μm. Accordingly, the electrically conductive layer 230, in which the electrically conductive polymer and the carbon filler are uniformly dispersed in the ion liquid, can be densely formed on the surface of the cathode part 212 to patch and repair surface defects, thereby increasing the reliability of the low leakage electrolytic capacitor 200.

To sum up, the hybrid electrically conductive medium contains an ion liquid and an electrically conductive polymer. The ion liquid, which can serve as a dispersing medium, is operable over a wide temperature range and has the advantages of high thermal stability, high electrical conductivity, and good electrochemical properties. The electrically conductive polymer is uniformly and stably dispersed in the ion liquid in the form of solid particles to allow easy transport of electrons and ions. The hybrid electrically conductive medium may additionally contain a lower volatility solvent for increasing thermal stability and electrical conductivity and a carbon filler for providing electrical conduction paths between the particles of the electrically conductive polymer. According, a capacitor with high mechanical strength and good electrical properties can be obtained, and is capable of undergoing stable high speed charging/discharging cycles.

Moreover, the hybrid electrically conductive medium can be provided with the functions of hole-filling, defect repairing, and current leakage preventing. Therefore, the low leakage electrolytic capacitor according to the embodiments of the invention has excellent properties of both solid electrolytic capacitor and liquid electrolytic capacitor.

In addition, the electrically conductive layer, in which the electrically conductive polymer and the carbon filler are uniformly dispersed in the ion liquid, can be densely formed on the surface of the cathode part to patch and repair surface defects, thereby increasing the reliability of the low leakage electrolytic capacitor.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. A low leakage electrolytic capacitor, comprising:
a winding-type capacitor element including an anode foil, a cathode foil, and a separator interposed between the anode foil and the cathode foil;
a hybrid electrically conductive medium disposed in the winding-type capacitor element, including an electrically conductive polymer and an ion liquid, wherein the ion liquid contains at least one cationic species selected from the group consisting of formulae (1) to (9) and at least one anionic species selected from the group consisting of formulae (10) to (17): 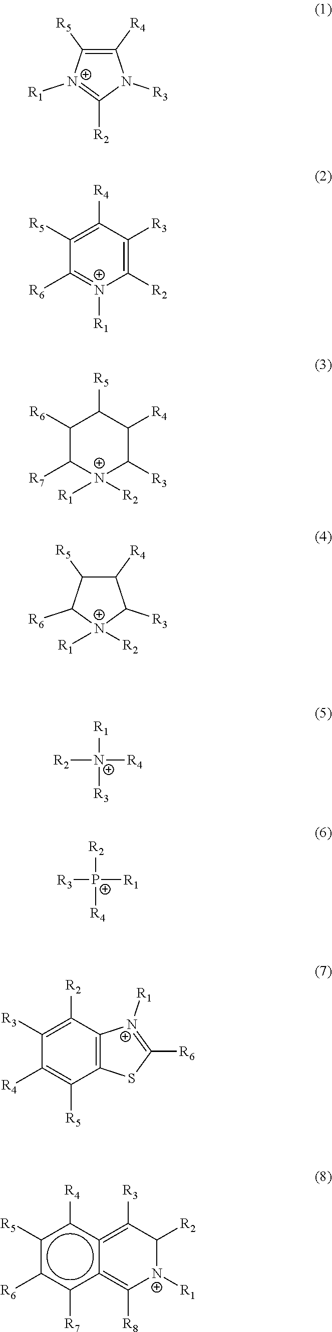 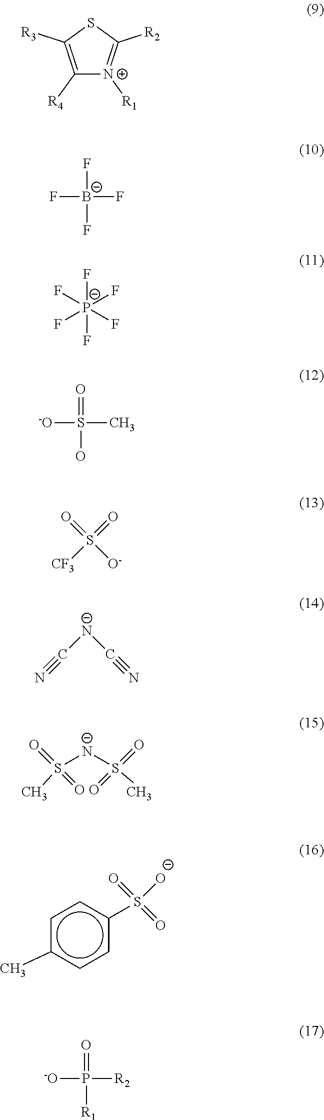
wherein R₁ to R₈ each independently represent a hydrogen atom, substituted or unsubstituted C1-C10 alkyl group, unsubstituted or substituted C1-C10 alkenyl group, unsubstituted or substituted C1-C10 alkynyl group, substituted or unsubstituted aryl group, substituted or unsubstituted heteroaryl group, acyl group, ester group, ether group, or amino group; and
a package body enclosing the winding-type capacitor element and the hybrid electrically conductive medium.

2. The low leakage electrolytic capacitor of claim 1, wherein the electrically conductive polymer is polyethylene dioxythiophene doped with polystyrene-sulfonic acid (PEDOT/PSS), polythiophene (PT), polyacetylene (PA), polyaniline (PANI), or polypyrrole (PPy).

3. The low leakage electrolytic capacitor of claim 1, wherein the electrically conductive polymer is present in an amount of from about 1.0 to about 20.0 weight percent of the hybrid electrically conductive medium, and the ion liquid is present in an amount of from about 0.05 to about 30.0 weight percent of the hybrid electrically conductive medium.

4. The low leakage electrolytic capacitor of claim 1, wherein the hybrid electrically conductive medium further contains a lower volatility solvent which is present in an amount of from about 0.05 to about 50.0 weight percent of the hybrid electrically conductive medium.

5. The low leakage electrolytic capacitor of claim 4, wherein the lower volatility solvent is one or a combination of two or more selected from the group consisting of polyalkylene glycol or a derivative thereof, polyethylene glycol or a derivative thereof, polypropylene glycol or a derivative thereof, polytetramethylene glycol or a derivative thereof, a copolymer of ethylene glycol and propylene glycol, a copolymer of ethylene glycol and butylene glycol, and a copolymer of polypropylene glycol and butylene glycol.

6. The low leakage electrolytic capacitor of claim 1, wherein the hybrid electrically conductive medium further contains a carbon filler which is present in an amount of from about 0 to about 5 weight percent of the hybrid electrically conductive medium.

7. The low leakage electrolytic capacitor of claim 6, wherein the carbon filler includes carbon nanotube and graphene.

8. The low leakage electrolytic capacitor of claim 1, wherein the hybrid electrically conductive medium further contains 10 to 10000 ppm of alkaline metal or alkali earth metal ions.
